(19) United States
(12) Patent Application Publication
(10) Pub. No.: US 2023/0259385 A1
(43) Pub. Date: Aug. 17, 2023

(54) METHODS AND SYSTEMS FOR HYPERPARAMETER TUNING AND BENCHMARKING

(71) Applicant: 1QB Information Technologies Inc., Vancouver (CA)

(72) Inventors: Gilad Amir ROSENBERG, Vancouver (CA); Silvan Shiwa KUTTIMALAI, Cumberland (CA); Elisabetta VALIANTE, Vancouver (CA); Maliheh ARAMON BAJESTANI, North Vancouver (CA); Tamuno-Tonye BROWN, Seattle, WA (US); Clemens ADOLPHS, North Vancouver (CA); Chadwin Ross COLGUR, Rossland (CA)

(21) Appl. No.: 18/297,513

(22) Filed: Apr. 7, 2023

Related U.S. Application Data
(63) Continuation of application No. PCT/IB2021/059421, filed on Oct. 13, 2021.
(60) Provisional application No. 63/091,175, filed on Oct. 13, 2020.

(51) Int. Cl. G06F 9/455

(52) U.S. Cl. CPC G06F 9/45558; G06F 2009/4557; G06F 2009/45562

(57) ABSTRACT

The present disclosure provides methods and systems for hyperparameter tuning and benchmarking.

### CROSS-REFERENCE

This application is a continuation of International Application No. PCT/IB2021/059421, filed Oct. 13, 2021, which claims the benefit of U.S. Provisional Application No. 63/091,175, filed Oct. 13, 2020, which application is incorporated herein by reference.

### BACKGROUND

Most hyperparameter tuning and benchmarking tools deal with only part of the tuning or benchmarking task, while the full pipeline of the process can include configuring experiments, running the experiments, recording the results in a database, and visualizing and analyzing the results. Additionally, these tools can have a limited selection of tuners and not allow for adding custom tuners.

### SUMMARY

Hyperparameter tuning frameworks may be built specifically for machine learning applications. They may not have a concept of a problem or a best-known objective function value, solve each problem multiple times, have appropriate metrics implemented (e.g., time to solution), or support complicated but realistic hyperparameter constraints. Using such constraints can avoid obviously wrong or ineffective configurations, thereby speeding up the hyperparameter optimization.

Recognized herein is the need for improved methods and systems that can overcome at least one of the above-identified drawbacks. The present disclosure provides methods and systems for hyperparameter tuning of a computational procedure and for benchmarking of the computational procedure.

An advantage of one or more embodiments of the methods and systems disclosed herein may be the implementation of all the operations to automate the process of tuning and benchmarking, while still allowing step by step manual control and inspection. Another advantage of one or more embodiments of the methods and systems disclosed herein may be providing access to multiple hyperparameter optimization procedures or algorithms. In addition, the modularity of the disclosed methods may allow users to easily add new hyperparameter optimization procedures, or to customize the existing ones.

Another advantage of one or more embodiments of the methods and systems disclosed herein may be the support of optimization use-cases where the goal is to find the optimal parameters of an optimization solver using a specific problem class. More specifically, a concept of a problem/computational task and a best-known objective function value may be known, thus allowing for solving each problem multiple times, and allowing for appropriate metrics to be used and implemented (such as time to solution). For example, a system can be configured to find the optimal parameters of a simulated annealing solver such that the computation time to solve multiple knapsack problem instances to optimality is minimized.

Another advantage of one or more embodiments of the methods and systems disclosed herein may be the support of complicated but realistic hyperparameter constraints. For example, temperature values of replicas can be hyperparameters in a parallel tempering algorithm and can be chosen such that all are different and are monotonically decreasing. Another advantage of one or more embodiments of the methods and systems disclosed herein may be working in concert with new technologies such as quantum and application-specific computing.

In an aspect, the present disclosure provides a computer-implemented method, the method comprising: (a) using an interface of a digital computer to obtain an indication of: (i) a problem class comprising at least one computational task, (ii) a hyperparameter search space, (iii) a computational procedure, and (iv) at least one metric for evaluating a performance of the computational procedure; (b) until a stopping criterion is met: (i) using the digital computer to generate a hyperparameter configuration from the hyperparameter search space, and storing the hyperparameter configuration in memory; (ii) using the hyperparameter configuration to perform benchmarking on the computational procedure, the benchmarking comprising: (a) using a computational platform to: i. perform the computational procedure for each computational task of the problem class, wherein the each computational task of the problem class is configured using at least the hyperparameter configuration, and ii. store a result generated upon performance of the computational procedure in memory, and (b) calculating a value of the at least one metric to evaluate the result corresponding to a performance of the computational procedure, and storing the value in memory; (c) using the result and the value to select at least one hyperparameter configuration from the hyperparameter configuration of (b); and (d) electronically outputting the at least one hyperparameter configuration selected in (c) and the result corresponding to the performance of the at least one hyperparameter configuration selected in (c).

In some embodiments, the using the digital computer to generate the hyperparameter configuration from the hyperparameter search space is performed using the result and the value of the at least one metric. In some embodiments, (a) further comprises obtaining a hyperparameter optimization algorithm, wherein the using the digital computer to generate the hyperparameter configuration is performed using the hyperparameter optimization algorithm. In some embodiments, (a) further comprises obtaining at least one hyperparameter constraint, wherein the using the digital computer to generate the hyperparameter configuration comprises evaluation of the at least one hyperparameter constraint. In some embodiments, (c) further comprises generating an interactive visualization of the result and the value. In some embodiments, the computational task is an optimization task. In some embodiments, the at least one hyperparameter configuration selected in (c) comprises a tuned hyperparameter configuration. In some embodiments, the benchmarking occurs in an absence of tuning the hyperparameter configuration.

In another aspect, the present disclosure provides a system configured to benchmark at least one computational procedure using at least one problem class, each problem class comprising at least one computational task, the system comprising: (a) a digital computer comprising an interface and a non-transitory computer readable medium operatively coupled to a processor, the non-transitory computer readable medium comprising instructions, wherein the processor is configured to execute the instructions to at least: (i) obtain an indication of: (a) a problem class comprising a computational task, (b) a hyperparameter search space, (c) a computational procedure, and (d) at least one metric for evaluating a performance of the computational procedure, (ii) generate a hyperparameter configuration from the hyperparameter search space, and store the hyperparameter configuration in memory; (b) a memory operatively coupled to the digital computer, wherein the memory stores at least a computational result and value of the at least one metric; and (c) a computational platform operatively coupled to the digital computer, the computational platform comprising at least one processor and a readout control system, wherein the computational platform is configured at least to: (i) receive from the digital computer an indication of the problem class comprising the computational task, the computational procedure, and the hyperparameter configuration, and (ii) perform the computational procedure using a received hyperparameter configuration to generate a result, and (iii) via the readout control, store the result of the computational procedure in memory.

In some embodiments, the digital computer comprises multiple processors that are configured to perform the at least one computational procedure in parallel. In some embodiments, the computational platform is further configured to receive at least one metric for evaluating a performance of the computational procedure and to calculate a value of the at least one metric and store the value in a memory. In some embodiments, the digital computer is further configured to calculate a value of the at least one metric and store the value in the memory. In some embodiments, the computational platform comprises at least one member selected from the group consisting of a field-programmable gate array (FPGA), an application-specific integrated circuit (ASIC), a central processing unit (CPU), a graphics processing unit (GPU), a tensor processing unit (TPU), a tensor streaming processor (TSP), a quantum computer, a quantum annealer, an integrated photonic coherent Ising machine, or an optical quantum computer. In some embodiments, the system further comprises a plurality of virtual machines, and optionally wherein the plurality of virtual machines is hosted on the computational platform. In some embodiments, the memory is operatively coupled to the digital computer over a network. In some embodiments, one or more processors of the at least one processor is located on a cloud. In some embodiments, the indication of the computational procedure comprises an indication of a computer-implemented method and a type of hardware. In some embodiments, an indication of the computational procedure comprises an indication of a meta-solver comprising two or more computational procedures. In some embodiments, the memory is part of a database. In some embodiments, the system is configured to set an automated pipeline. In some embodiments, the automated pipeline comprises hyperparameter tuning or benchmarking.

In another aspect, the present disclosure provides a method for setting an automated pipeline comprising hyperparameter tuning and benchmarking, the method comprising: (a) selecting one or more computational procedures; (b) selecting one or more hardware types; (c) determining whether to tune a hyperparameter for the selected one or more computational procedures, and, if so determined: (i) selecting a hyperparameter search space corresponding to the selected one or more computational procedures and the one or more hardware types; (ii) determining how to select a computational task sample; (d) determining whether to benchmark the selected one or more computational procedures; and (e) determining whether to visualize the tuning and the benchmarking results.

In some embodiments, the one or more hardware types comprises at least two machines, and wherein the automated pipeline comprises: (a) receiving an indication of at least one problem class comprising a plurality of computational tasks, at least one computational procedure, and at least one metric for evaluating a performance of the at least one computational procedure; (b) for each problem class of the at least one problem class: (i) selecting a sample of a computational task of the plurality of computational tasks comprising at least one computational task from the problem class, (ii) for each computational procedure of the at least one computational procedure: (a) generating one or more hyperparameter configurations, (b) using the computational task sample to benchmark the computational procedure, the benchmark comprising performing the computational procedure for each of the selected computational tasks using the at least two machines and evaluating results generated by the performing by calculating values of the at least one metric and storing the values in the database, (c) providing the results comprising hyperparameter configurations and corresponding computational results, (d) repeating (a)-(c) until a stopping criterion is met, and (e)selecting at least one hyperparameter configuration using results of the benchmarking, (iii)using remaining computational tasks and the hyperparameter configuration to benchmark each of the at least one computational procedure; and (c) generating an interactive visualization of benchmarking results from (iii) comprising the hyperparameter configurations, corresponding computational results, and values of the at least one metric.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 is an example schematic diagram of a system configured to set an automated pipeline for hyperparameter tuning of a computational procedure and/or for benchmarking the computational procedure.

FIG. 2 is a flow chart of an example method for hyperparameter tuning of a computational procedure and for benchmarking the computational procedure.

FIG. 3 is an example of a benchmarking procedure.

FIG. 4 is a flow chart of an example process for an automated pipeline 400 comprising hyperparameter tuning on one or more problem sets and benchmarking a computational procedure.

FIG. 5 is an example of an interactive visualization in static view.

FIG. 6 shows a computer system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

As used herein, the term “computational procedure” generally refers to any series of operations taken by a computational device. The computational procedure may be given some input and/or provide some output.

As used herein, the term “benchmarking” generally refers to evaluating the performance of a computational procedure by measuring or calculating one or more metrics and/or various statistics of the one or more metrics. The statistics may be mean, median, variance, or the like, or any combination thereof. The benchmarking may comprise comparing the performance (e.g., the metric value and/or its statistics) of this computational procedure with the performance of other computational procedures used for the same computational tasks.

As used herein, the term “hyperparameter” generally refers to a parameter whose value is used to control the performance of a computational procedure.

As used herein, the terms “hyperparameter tuning” and “hyperparameter optimization” generally refer to finding a value for one or more hyperparameters such that the performance of a computational procedure using the computational task is optimized.

As used herein, the term “hyperparameter search space” generally refers to a set of values and/or ranges that a particular hyperparameter can take, and/or a distribution from which these values or range are drawn (e.g., a logarithmic distribution).

As used herein, the term “hyperparameter constraint” generally refers to a relation that is fulfilled between at least two hyperparameter values (e.g., the hyperparameter x value is smaller or equal to the hyperparameter y value, if the hyperparameter x value is larger than 100 then the hyperparameter y value is larger than 20, etc.).

Computational tasks, computational procedures, and the corresponding hyperparameters may be of various types. For example, computational tasks, computational procedures, and the corresponding hyperparameters may be of any type disclosed herein. Examples include, but are not limited to, tuning the parameters of an optimization solver hyperparameters and benchmarking the optimization solver for solving a discrete optimization problem, tuning hyperparameters of a trading algorithm and the benchmarking thereof, and tuning hyperparameters of a machine learning model and the benchmarking thereof.

### Computational Platform

A computational platform may comprise various types of hardware in any combination. Each of the types of hardware may be used as part of the system, to execute a method or any part of the method, alone or in combination with other hardware. In some cases, the hardware may be used for various operations of the methods disclosed herein, such as, for example, one or more of generating a hyperparameter configuration from a hyperparameter search space, performing a computational procedure (or any portion thereof) for a computational task, calculating a metric for evaluating the performance of a computational procedure, generating interactive visualization of the tuning and/or benchmarking results, evaluation of an objective function given a hyperparameter configuration, evaluation of a constraint given a hyperparameter configuration, storing and/or retrieving results, selecting a best hyperparameter configuration given the results of tuning, or the like, or any combination thereof.

A computational platform may comprise a central processing unit (CPU). A CPU may be a low latency integrated circuit chip which comprises the main processor in a computer. A CPU may execute instructions as given by an algorithm. A CPU may comprise a component configured to do one or more of the following: executing arithmetic and logic operations, registering to store the results of the operations, directing the operations using a control unit, or the like, or any combination thereof. A computational platform may comprise a graphics processing unit (GPU). A GPU may be an electronic circuit optimized for high throughput (e.g., can perform the same set of operations in parallel on many data blocks at a time). A computational platform may comprise a field-programmable gate array (FPGA). An FPGA may comprise an integrated circuit chip that comprises configurable logic blocks and programmable interconnects. An FPGA may be programmed after manufacturing to execute custom algorithms. A computational platform may comprise an application-specific integrated circuit (ASIC). An ASIC may be an integrated circuit chip customized to run a specific algorithm. An ASIC may not be able to be programmed after manufacturing. A computational platform may comprise a tensor processing unit (TPU). A TPU may comprise a proprietary type of ASIC developed for low bit precision processing by Google® Inc., see Patent Application US 2016/0342891, which is incorporated entirely herein by reference for all purposes. A computational platform may comprise a tensor streaming processor (TSP). A TSP may be a domain-specific programmable integrated chip designed for linear algebra computations as performed in Artificial Intelligence applications. An example of a TSP may be found in Linley Gwennap, “Grog rocks neural networks,” Microprocessor Report, January 2020, which is incorporated entirely herein by reference for all purposes.

### Non-Classical Computers

In an aspect, the present disclosure provides systems and methods that may include quantum computing and/or the use of quantum computing. Quantum computers may be able to solve certain classes of computational tasks more efficiently than classical computers. Quantum computation resources may be rare and/or expensive and may involve a certain level of expertise to be used efficiently or effectively (e.g., cost-efficiently, cost-effectively). A number of parameters may be tuned in order for a quantum computer to deliver its fully potential of computational power. Quantum computers and/or other types of non-classical computers may be able to work alongside classical computers as co-processors. A hybrid architecture (e.g., computing system) comprising a classical computer and a quantum computer can be efficient for addressing complex computational tasks, such as, for example, an optimization problem of a large size.

Although the present disclosure has referred to quantum computers, methods and systems of the present disclosure may be employed for use with other types of computers. The other types of computers may be non-classical computers. Non-classical computers may comprise quantum computers, hybrid quantum computers, quantum-type computers, or other computers that are not classical computers, or any combination thereof. Examples of non-classical computers may include, but are not limited to, Hitachi Ising solvers, coherent Ising machines based on optical parameters, and other solvers which utilize different physical phenomena to obtain more efficiency in solving particular classes of problems.

In some cases, a quantum computer may comprise one or more adiabatic quantum computers, quantum gate arrays, one-way quantum computers, topological quantum computers, quantum Turing machines, superconductor-based quantum computers, trapped ion quantum computers, trapped atom quantum computers, optical lattices, quantum dot computers, spin-based quantum computers, spatial-based quantum computers, Loss-DiVincenzo quantum computers, nuclear magnetic resonance (NMR) based quantum computers, solution-state NMR quantum computers, solid-state NMR quantum computers, solid-state NMR Kane quantum computers, electrons-on-helium quantum computers, cavity-quantum-electrodynamics based quantum computers, molecular magnet quantum computers, fullerene-based quantum computers, linear optical quantum computers, diamond-based quantum computers, nitrogen vacancy (NV) diamond-based quantum computers, Bose-Einstein condensate-based quantum computers, transistor-based quantum computers, rare-earth-metal-ion-doped inorganic crystal-based quantum computers, or the like, or any combination thereof. A quantum computer may comprise one or more quantum annealers, Ising solvers, optical parametric oscillators (OPO), gate models of quantum computing, or the like, or any combination thereof. A computational platform may comprise one or more non-classical computers which may be a gate model quantum computer. A gate model quantum computer may comprise one or more quantum bits, referred to as qubits, and one or more networks of quantum logic gates. In a gate model, quantum computer computations may be performed by initializing quantum states, running the quantum states through a sequence of quantum gates (e.g., a quantum circuit), and performing measurements on the states.

A computational platform may comprise a non-classical computer. The non-classical computer may comprise a quantum annealer. A quantum annealer may comprise a quantum mechanical system comprising manufactured qubits, local field biases, couplings between pairs of qubits, or the like, or any combination thereof. The biases and/or couplings may be controllable. A quantum annealer may allow the quantum annealer to be programmed such that it can be used as a heuristic solver for Ising problems (e.g., equivalent to quadratic unconstrained binary optimization (QUBO) problems). For examples, see McGeoch and Wang, “Experimental Evaluation of an Adiabatic Quantum System for Combinatorial Optimization,” Computing Frontiers, May 14-16, 2013 and Patent Application US 2006/0225165, each of which are incorporated entirely herein by reference for all purposes.

The non-classical computer may comprise an optical computing device. An example of an analogue system which may be suitable for technology disclosed herein is an optical device. In some cases, the optical device comprises a network of optical parametric oscillators (OPOs) as disclosed in the patent applications US 2016/0162798 and WO 2015006494, each of which are each incorporated herein by reference in their entireties.

The non-classical computer may comprise an integrated photonic coherent Ising machine. An example of an analogue system which may be suitable for technology disclosed herein is an integrated photonic coherent Ising machine. The integrated photonic coherent Ising machine may be as disclosed in the patent application US 2018/0267937, which is incorporated entirely herein by reference for all purposes. In some cases, an Integrated photonic coherent Ising machine may comprise a combination of nodes and/or a connection network for solving a particular Ising problem. In some cases, the combination of nodes and/or the connection network may form an optical computer that is adiabatic. The combination of the nodes and the connection network may be configured to non-deterministically solve an Ising problem when the values stored in the nodes reach a steady state to minimize the energy of the nodes and the connection network. Values stored in the nodes at the minimum energy level may be associated with values that solve a particular Ising problem. The stochastic solutions may be used as samples from a Boltzmann distribution defined by a Hamiltonian corresponding to the Ising problem.

In some cases, the systems, media, networks, and/or methods described herein may comprise a classical computer and/or the use of the same. In some cases, a classical computer may comprise a digital computer. In some cases, the classical computer may include one or more hardware central processing units (CPUs) that carry out the functions of the classical computer. In some cases, the classical computer can further comprise an operating system (OS) configured to perform executable instructions. In some cases, the classical computer may be connected to a computer network. In some cases, the classical computer can be connected to the Internet such that it accesses the World Wide Web. In some cases, the classical computer may be connected to a cloud computing infrastructure. In some cases, the classical computer may be connected to an intranet. In some cases, the classical computer may be connected to a data storage device. Suitable classical computers may include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, vehicles, or the like. Smartphones may be suitable for use with methods and systems described herein. Televisions, video players, and digital music players, in some cases with computer network connectivity, may be suitable for use in the systems and methods described herein. Tablet computers may include those with booklet, slate, and convertible configurations.

In some cases, the classical computer can include an operating system configured to perform executable instructions. The operating system may be, for example, software, including programs and data, which manages the device's hardware and provides services for execution of applications. Suitable server operating systems include, by way of non-limiting examples, FreeBSD, OpenBSD, NetBSD®, Linux, Apple® Mac OS X Server®, Oracle® Solaris®, Windows Server®, Novell® NetWare®, or the like. Suitable personal computer operating systems may include, by way of non-limiting examples, Microsoft® Windows®, Apple® Mac OS X®, UNIX®, UNIXlike operating systems such as GNU/Linux®, or the like. In some cases, the operating system is provided by cloud computing. Suitable mobile smart phone operating systems may include, by way of nonlimiting examples, Nokia® Symbian® OS, Apple® iOS®, Research In Motion® BlackBerry OS®, Google® Android®, Microsoft® Windows Phone® OS, Microsoft® Windows Mobile® OS, Linux®, Palm® WebOS®, or the like. Suitable media streaming device operating systems may include, by way of non-limiting examples, Apple TV®, Roku®, Boxee®, Google TV®, Google Chromecast®, Amazon Fire®, Samsung® HomeSync®, or the like. Suitable video game console operating systems may include, by way of non-limiting examples, Sony® PS3®, Sony® PS4®, Microsoft® Xbox 360®, Microsoft Xbox One, Nintendo® Wii®, Nintendo® Wii Ouya®, or the like. In some cases, the classical computer includes a storage and/or memory device. In some cases, the storage and/or memory device is one or more physical apparatuses used to store data or programs on a temporary and/or permanent basis. In some cases, the device comprises volatile memory and can use power to maintain stored information. In some cases, the device comprises non-volatile memory and can retain stored information when the classical computer is not powered on. In some cases, the non-volatile memory comprises flash memory. In some cases, the non-volatile memory comprises dynamic random-access memory (DRAM). In some cases, the non-volatile memory comprises ferroelectric random-access memory (FRAM). In some cases, the nonvolatile memory comprises phase-change random access memory (PRAM). In other embodiments, the device comprises a storage device including, by way of non-limiting examples, CDROMs, DVDs, flash memory devices, magnetic disk drives, magnetic tapes drives, optical disk drives, cloud computing based storage, or the like. In some cases, the storage and/or memory device comprises a combination of devices such as those described elsewhere herein.

In some cases, the classical computer includes a display to send visual information to a user. In some cases, the display comprises a cathode ray tube (CRT). In some cases, the display comprises a liquid crystal display (LCD). In some cases, the display comprises a thin film transistor liquid crystal display (TFT-LCD). In some cases, the display comprises an organic light emitting diode (OLED) display. In some cases, on OLED display comprises a passive-matrix OLED (PMOLED) or an active matrix OLED (AMOLED) display. In some cases, the display comprises a plasma display. In other embodiments, the display comprises a video projector. In some cases, the display comprises a combination of devices such as those described elsewhere herein.

In some cases, the classical computer may comprise one or more input devices to receive information from a user. In some cases, the input device may comprise a keyboard. In some cases, the input device may comprise a pointing device including, by way of non-limiting examples, a mouse, trackball, track pad, joystick, game controller, stylus, or the like. In some cases, the input device may comprise a touch screen and/or a multitouch screen. In some cases, the input device may comprise a microphone. The microphone may be configured to capture voice and/or other sound input. In some cases, the input device may comprise a video camera and/or other sensor to capture motion and/or visual input. For example, the input device can comprise a camera configured as a biometric security lock. In some cases, the input device may comprise a Kinect, Leap Motion, or the like. In some cases, the input device may comprise a combination of devices such as those disclosed herein.

In some cases, the methods and systems disclosed herein may comprise a modular design. The modular design may allow for utilization of new technologies in different methods where computationally expensive procedures are implemented on special-purpose hardware and/or on massively parallel devices such as one or more FPGAs, GPUs, ASICs, or the like, or any combination thereof. For example, a portion of a method can be performed using an FPGA, while another portion is performed on a digital computer.

Methods and systems for hyperparameter tuning and benchmarking

In another aspect, the present disclosure provides computer-implemented methods and systems. A computer-implemented method may comprise using an interface of a digital computer to obtain an indication of a problem class comprising at least one computational task, a hyperparameter search space, a computational procedure, at least one metric for evaluating a performance of the computational procedure, or any combination thereof. Until a stopping criterion is met, the digital computer may be used to generate a hyperparameter configuration from the hyperparameter search space. The hyperparameter configuration may be stored in memory. The hyperparameter configuration may be used to perform benchmarking of the computational procedure. The benchmarking may comprise using a computational platform to perform the computational procedure for each computational task of the problem class. Each computational task of the problem class may be configured using at least the hyperparameter configuration. A result generated upon performance of the computational procedure may be stored in memory. A value of the at least one metric may be calculated to evaluate the result corresponding to a performance of the computational procedure. The value may be stored in memory. The result and the value may be used to select at least one hyperparameter configuration from the hyperparameter configuration. The at least one selected hyperparameter configuration and the result corresponding to the performance of the at least one hyperparameter configuration may be electronically output.

The using the digital computer to generate the hyperparameter configuration from the hyperparameter search space may be performed using the result and the value of the at least one metric. For example, a result and a value generated by a previous hyperparameter configuration can be used to inform the generation of a new hyperparameter configuration. In this example, the new hyperparameter configuration can be compared to the previous hyperparameter configuration to determine the optimal hyperparameter configuration. In another example, a plurality of hyperparameter configurations can be generated using the result and the value. The method may further comprise obtaining a hyperparameter optimization algorithm. The using the digital computer to generate the hyperparameter configuration may be performed using the hyperparameter optimization algorithm. The hyperparameter optimization algorithm may take as inputs the result, the value, the hyperparameter configuration related to the result, previous hyperparameter configurations, or the like, or any combination thereof. For example, the hyperparameter optimization algorithm can be configured to iterate different hyperparameter configurations to optimize the value of the hyperparameter configuration.

The method may comprise obtaining at least one hyperparameter constraint. The hyperparameter constraint may be a hyperparameter constraint as described elsewhere herein. The using the digital computer to generate the hyperparameter configuration may comprise evaluation of the at least one hyperparameter constraint. For example, the digital computer may be configured to generate a hyperparameter configuration, check the hyperparameter configuration against the hyperparameter constraint, and reject the hyperparameter configuration if the hyperparameter configuration is not permitted by the hyperparameter constraint. In another example, the digital computer can input the hyperparameter constraint into the process of generating the hyperparameter configuration to avoid hyperparameter configurations that are not permitted by the hyperparameter configuration.

The method may comprise generating an interactive visualization of the result and the value. An example of an interactive visualization can be found in Example 4. The interactive visualization may be displayed on a screen of a user. The interactive visualization may comprise a plurality of results and a plurality of values for a plurality of hyperparameter configurations. For example, the interactive visualization can permit selecting a hyperparameter configuration of a plurality of hyperparameter configurations to display along with the associated results and values. The interactive visualization may be configured to permit a user to select a hyperparameter configuration. The selecting the hyperparameter configuration may be selecting the hyperparameter configuration for use in another implementation of the computational procedure. For example, a user can select a hyperparameter configuration to be used on an implementation of a machine learning algorithm for another dataset. The method may comprise generating a static visualization of the result and the value. For example, the visualization can be a non-interactable image.

The computational task may comprise an optimization task. The computational task may be an optimization task. The optimization task may be a machine learning based optimization task. The optimization task may comprise a simulated annealing optimization, a gradient descent optimization, or the like, or any combination thereof. The computational task may comprise one or more different tasks. Non-limiting examples of tasks may include simulation tasks (e.g., quantum mechanical simulation, material simulation, etc.), design tasks (e.g., generating a design, generating a structure, etc.), processing tasks (e.g., image processing, feature identification, labeling, etc.), or the like, or any combination thereof. The at least one hyperparameter may comprise a tuned hyperparameter configuration. The tuning may comprise optimization for a predetermined task. For example, a tuned hyperparameter configuration can be configured to optimally perform a particular simulation. In another example, a tuned hyperparameter configuration can be configured to perform faster than other hyperparameter configurations. A tuned hyperparameter configuration may be tuned for one or more aspects (e.g., evaluation metrics as described elsewhere herein). The tuning may comprise adjusting one or more hyperparameters of the hyperparameter configuration. For example, a hyperparameter configuration can be tuned by adjusting a hyperparameter until an optimal value for the hyperparameter configuration is determined, and subsequently similarly tuning other hyperparameters until a global optimum is found. The benchmarking may occur in an absence of tuning the hyperparameter configuration. For example, the benchmarking can be performed for a plurality of hyperparameter configurations without adjusting or otherwise tuning the hyperparameter configurations. In this example, the various hyperparameter configurations that are benchmarked can be compared and an optimal hyperparameter configuration can be selected.

The present disclosure provides methods and systems for benchmarking at least one computational procedure using at least one problem class, each problem class comprising at least one computational task. A system for benchmarking at least one computational procedure using at least one problem class, each problem class comprising at least one computational task may comprise a digital computer comprising an interface and a non-transitory computer readable medium operatively coupled to a processor. The non-transitory computer readable medium may comprise instructions. The processor may be configured to execute the instructions to at least obtain an indication of a problem class comprising a computational task, a hyperparameter search space, a computational procedure, at least one metric for evaluating a performance of the computational procedure, or any combination thereof. A hyperparameter configuration may be generated from the hyperparameter search space. The hyperparameter configuration may be stored in memory. A memory may be operatively coupled to the digital computer. The memory may store at least a computational result and/or a value of the at least one metric. A computational platform may be operatively coupled to the digital computer. The computational platform may comprise at least one processor and a readout control system. The computational platform may be configured at least to receive from the digital computer an indication of the problem class comprising the computational task, the computational procedure, and/or the hyperparameter configuration. The computational procedure may be performed using a received hyperparameter configuration to generate a result. Via the readout control, the result of the computational procedure may be stored in memory.

The digital computer may comprise multiple processors that may be configured to perform the at least one computational procedure in parallel. The digital computer may comprise multiple processor cores that may be configured to perform the at least one computational procedure in parallel. The digital computer may comprise at least about 1, 2, 3, 4, 5, 6, 7, 8, 9, 10, 50, 100, 500, 1,000, 5,000, 10,000, 50,000 or more processors and/or processor cores. The digital computer may comprise at most about 50,000, 10,000, 5,000, 1,000, 500, 100, 50, 10, 9, 8, 7, 6, 5, 4, 3, 2, or fewer processors and/or processor cores.

The computational platform may be configured to receive at least one metric for evaluating a performance of the computational procedure. The digital computer may be configured to calculate a value of the at least one metric. The metric may be, for example, a target value (e.g., an ideal or expected value), a speed (e.g., a length of time to complete the computational procedure), a resource utilization (e.g., an amount of resource used to perform the computational procedure), an accuracy, other metrics as described elsewhere herein, or the like, or any combination thereof. The computational platform may be configured to calculate a value of the at least one metric and store the value in a memory. For example, the computational platform can calculate how long it took for a computational procedure to run and how accurate the computational procedure was as compared to a true value. The digital computer may be configured to store the value in the memory.

The computational platform may be a computational platform as described elsewhere herein. The computational platform may comprise a field-programmable gate array (FPGA), an application-specific integrated circuit (ASIC), a central processing unit (CPU), a graphics processing unit (GPU), a tensor processing unit (TPU), a tensor streaming processor (TSP), a quantum computer, a quantum annealer, an integrated photonic coherent Ising machine, an optical quantum computer, or the like, or any combination thereof. The system may comprise one or more virtual machines. The virtual machines may be hosted on the computational platform. For example, the computational platform can provide the computing resources for the one or more virtual machines. The virtual machines may be hosted on the digital computer. The virtual machines may be hosted on a separate computational resource from the digital computer or the computational platform. The one or more virtual machines may be configured to execute the computational task. For example, a virtual machine can be configured to run a program container. Different computational tasks may be run on the same virtual machine. Different computational tasks may be run on different virtual machines.

The memory may be operatively coupled to the digital computer over a network. The network may be a network as described elsewhere herein. For example, the memory can be network attached storage memory for the digital computer. One or more processors of the at least one processor may be located on a cloud. The cloud may be a network computing resource. The cloud may be a cloud as described elsewhere herein (e.g., Amazon® Web Services, Microsoft® Azure®, etc.). The cloud may comprise one or more non-classical computers as described elsewhere herein. The memory may be a part of a database. The database may be a cloud database. For example, the memory can be memory in a database remote from the digital computer and/or the computational platform.

The indication of the computational procedure may comprise an indication of a computer-implemented method and/or a type of hardware. For example, the indication can be an indication of an optimization problem to be run on a quantum computer. In another example, the indication can be that the computational procedure is to be run on a non-classical computer. In another example, the computational procedure can indicate a same computer-implemented method and different types of hardware. In this example, the computational procedure can determine which type of hardware the computer-implemented method is optimally performed on. The indication of the computational procedure may comprise an indication of a meta-solver. The meta-solver may comprise two or more computational procedures. The meta-solver may be configured to select a computational procedure from the two or more computational procedures. For example, the meta-solver can solve which computational procedure provides an optimal solution to a given problem. The meta-solver may comprise a meta-heuristic. The meta-solver may be configured to be performed by the computational platform. The system may be configured to set an automated pipeline. The automated pipeline may be executed in an absence of an input from a user. For example, the system can be configured to automatically operate and perform the operations of the methods described elsewhere herein. The automated pipeline may comprise hyperparameter tuning and/or benchmarking. The hyperparameter tuning and/or benchmarking may be as described elsewhere herein.

The present disclosure provides methods and systems for setting an automated pipeline comprising hyperparameter tuning and benchmarking. A method for setting an automated pipeline comprising hyperparameter tuning and benchmarking may comprise selecting one or more computational procedures. One or more hardware types may be selected. Whether to tune a hyperparameter for the selected one or more computational procedures may be determined. If so determined, a hyperparameter search space corresponding to the selected one or more computational procedures and the one or more hardware types may be selected. How to select a computational task sample may be determined. Whether to benchmark the selected one or more computational procedures may be determined. Whether to visualize the tuning and the benchmarking results may be determined. The one or more hardware types may comprise at least two machines. The machines may be computational platforms, digital computers, or the like, or any combination thereof. The automated pipeline may comprise receiving an indication of at least one problem class comprising a plurality of computational tasks, at least one computational procedure, and at least one metric for evaluating a performance of the at least one computational procedure. For each computational procedure of the at least one computational procedure, one or more hyperparameter configurations may be generated. The computational task sample may be used to benchmark the computational procedure. The computational task sample may be used to tune one or more hyperparameters. The benchmark may comprise performing the computational procedure for each of the selected computational tasks using the at least two machines and evaluating results generated by the performing by calculating values of the at least one metric. The values may be stored in the database. The results comprising hyperparameter configurations and corresponding computational results may be proved. The previous operations may be repeated until a stopping criterion is met. At least one hyperparameter configuration may be selected using results of the benchmarking. The remaining computational tasks and the hyperparameter configuration may be used to benchmark each of the at least one computational procedure. An interactive visualization of benchmarking results may be generated comprising the hyperparameter configurations, corresponding computational results, and values of the at least one metric.

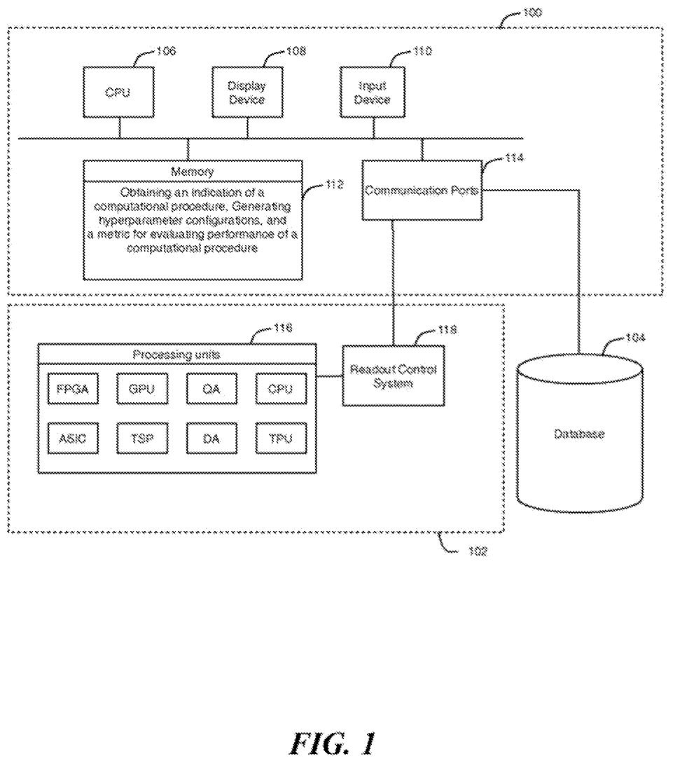

FIG. 1 is an example schematic diagram of a system configured to set an automated pipeline for hyperparameter tuning of a computational procedure and/or for benchmarking the computational procedure.

The system may comprise a digital computer 100. The digital computer may be a digital computer of various types, such as, for example, a digital computer as described elsewhere herein. The digital computer may comprise at least one processing device 106 and at least one memory 112. The at least one memory may comprise a computer program executable by the processing device 106 which may be configured to obtain an indication of a problem class comprising at least one computational task, a hyperparameter search space, a computational procedure, at least one metric for evaluating the performance of a computational procedure, or the like, or any combination thereof. The at least one memory may comprise a computer program executable by the processing device 106 which may be configured to generate a hyperparameter configuration from the hyperparameter search space, store the configuration in a database (e.g., database 104), benchmark the computational procedure, calculate values of the at least one metric, evaluate the results, select at least one hyperparameter configuration, generate interactive visualization of the results and the at least one metric values, or the like, or any combination thereof.

The system may comprise a computational platform 102 operatively connected to the digital computer 100. The computational platform 102 may comprise at least one processor 116. The at least one processor 116 may be of various types of processors such as, for example, the types of processors as described elsewhere herein. For example, the at least one processor can comprise at least one field-programmable gate array (FPGA), application-specific integrated circuit (ASIC), central processing unit (CPU), graphics processing unit (GPU), tensor processing unit (TPU), tensor streaming processor (TSP), quantum computer, quantum annealer, integrated photonic coherent Ising machine, optical quantum computer, or the like, or any combination thereof.

Each component of the system (e.g., the hardware) may be used as part of the system to execute a whole method, or any portion thereof, alone or in combination with other components (e.g., other hardware). In some cases, the components may be used for generating a hyperparameter configuration from a hyperparameter search space, performing a computational procedure for a computational task, calculating a metric for evaluation of a computational procedure performance, performing an optimization procedure, generating a visualization (e.g., an interactive visualization) of benchmarking results including a part or all of the above, or the like, or any combination thereof.

The computational platform 102 may be operatively connected to the digital computer 100. The computational platform may comprise a read-out control system 118. The read-out control system may be configured to read information (e.g., computational results, parameters, etc.) from the at least one processor 116. For example, the read-out control system can be configured to convert data from an FPGA to data usable by a digital computer. The system may comprise a database 104. The database may be operatively connected to the digital computer 100. The database may be a database of various types. The database may refer to a central repository configured to save the specification of the computational tasks and/or the computational procedure, record the values of the hyperparameters and/or the metrics and/or the associated statistics generated at each iteration performed during the tuning, make the history of the parameter space searched available to the hyperparameter optimizer to generate the next parameter configuration, or the like, or any combination thereof. In some cases, the database can be, for example, MongoDB.

The computational platform 102 and the database 104 may be connected to the digital computer 100 over a network. The computational platform, the database, and/or the digital computer can have network communication devices. The network communication devices can enable the computational platform, the database, and/or the digital computer to communicate with each other and with any number of user devices, over a network. The network can be a wired or wireless network. For example, the network can be a fiber optic network, Ethernet® network, a satellite network, a cellular network, a Wi-Fi® network, a Bluetooth® network, or the like. In other implementations, the computational platform, the database, and/or digital computer can be several distributed computational platforms, databases, and/or the digital computers that are accessible through the Internet. Such computational platforms, databases, and/or digital computers may be considered cloud computing devices. In some cases, the one or more processors of the at least one processor may be located in the cloud.

The at least one processor 116 may comprise one or more virtual machines. The one or more virtual machines may be one or more emulations of one or more computer systems. The virtual machines may be process virtual machines (e.g., virtual machines configured to implement a process in a platform-independent environment). The virtual machines may be systems virtual machines (e.g., virtual machines configured to execute an operating system and related programs). The virtual machine may be configured to emulate a different architecture from the at least one processor. For example, the virtual machine may be configured to emulate a quantum computing architecture on a silicon computer chip. Examples of virtual machines may include, but are not limited to, VMware®, VirtualBox®, Parallels®, QEMU®, Citrix® Hypervisor, Microsoft® Hyper-V®, or the like.

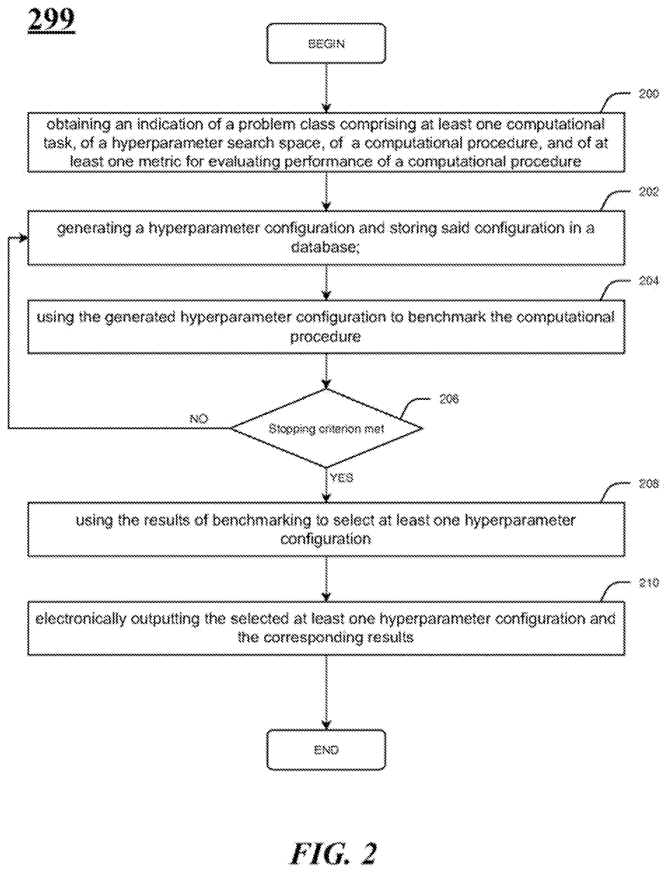

FIG. 2 is a flow chart of an example method 299 for hyperparameter tuning of a computational procedure and for benchmarking the computational procedure. In an operation 200, the method 299 may comprise obtaining an indication of a problem class, a hyperparameter search space, a computational procedure, and at least one metric for evaluating the performance of the computational procedure. The obtaining may be via an interface of a digital computer. The problem class may comprise at least one computational task. In some cases, the problem class may comprise a problem class as described elsewhere herein. In some cases, the problem class comprises an optimization problem. For example, the problem class can be an integer optimization or a binary optimization. In another example, the problem class can be supervised machine learning. The computational procedure may comprise any computational procedure such as, for example, one or more computational procedures as described elsewhere herein. The computational procedure may comprise branch and bound solvers such as, for example, Gurobi or CPLEX. The computational procedure may comprise an optimization procedure. The computational procedure may comprise one or more of simulated annealing, parallel tempering, population annealing, exhaustive search, greedy search, tabu search, path relinking, constraint simulated annealing, constraint parallel tempering, evolutionary search, or the like, or any combination thereof. The computational procedure may comprise one or more machine learning procedures such as, for example, supervised machine learning, unsupervised machine learning, reinforcement learning, or the like, or any combination thereof. The computational procedure may comprise a solver and/or a meta-solver comprising two or more computational procedures.

In some cases, an indication of the at least one computational procedure may comprise an indication of a computer-implemented method and a type of hardware.

The computational procedure and a type of hardware may define at least a portion of the hyperparameters to be tuned and/or the corresponding hyperparameter search space. The hyperparameters may be of various types such as, for example, hyperparameters described elsewhere herein. For example, the hyperparameters can be the initial and final temperature in a simulated annealing computational procedure. In another example, the hyperparameters can be the lengths of the short and long moving average periods in a trading algorithm. In another example, the hyperparameters can be the learning rate, the size of mini-batches, the number of hidden layers, and the dimensions of the hidden layers in a supervised learning model. The hyperparameter search space may be of various types. For example, the hyperparameter search space may be a set or a subset of integer numbers or real numbers.

The at least one metric for evaluating performance of a computational procedure may be of various types. For example, the metric can be the residual that is the relative difference between a solution obtained by the computational procedure and the best known solution. In another example, the metric can be the time to solution that measures the total computational time to find a best known solution at least once with a probability of 0.99.

Operation 200 may comprise obtaining at least one hyperparameter constraint. The hyperparameter constraint may be of various types such as, for example, any hyperparameter constraint as described elsewhere herein. For example, when the hyperparameters are the initial and final temperatures of a simulated annealing, the hyperparameter constraint can comprise restricting the initial temperature to be larger than the final temperature. In another example, when the hyperparameters are the lengths of the short and long moving average periods, the hyperparameter constraint can comprise restricting the period associated with the slow moving average to be longer than that associated with the fast moving average. In another example, a hyperparameter constraint for a machine learning algorithm with at least two hidden layers can be having the number of nodes in the second hidden layer be smaller than the number of nodes in the first hidden layer.

Operation 200 may comprise obtaining a hyperparameter optimization algorithm. The optimization algorithm can be of various types. For example, the optimization algorithm can be at least one grid search, random search, Bayesian optimization, sequential model-based optimization for general algorithm configuration, tree-structured Parzen estimator, or the like, or any combination thereof.

In another operation 202, the method 299 may comprise generating a hyperparameter configuration. The hyperparameter configuration may be generated using a digital computer. The hyperparameter configuration may be stored in a database. The database may be of various types such as, for example, a database as described elsewhere herein. For example, the database can be a database as described in FIG. 1. The hyperparameter configuration may be generating using the results and the calculated values of at least one metric. The hyperparameter configuration may be generated using the hyperparameter optimization algorithm. The generating the hyperparameter configuration may comprise evaluation of at least one hyperparameter constraint.

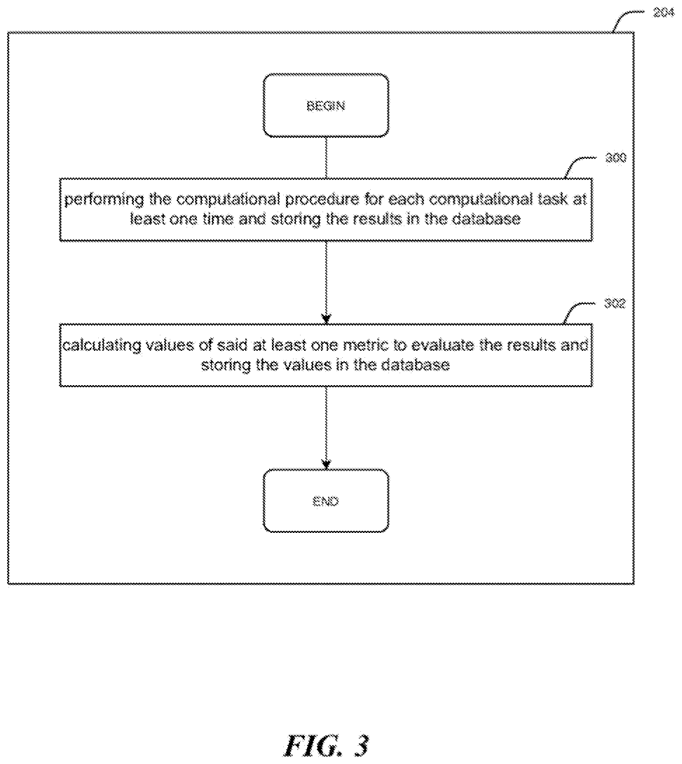

In another operation 204, the method 299 may comprise using the generated hyperparameter configuration to benchmark the computational procedure. An example of a benchmarking procedure can be found in FIG. 3. In another operation 206, a decision can be made as to if the stopping criterion has been met. The stopping criterion may be the number of iterations (e.g., that the number of iterations has reached a predetermined number). The stopping criterion may be that the best metric value yet obtained has not improved for a number of consecutive iterations. The number of consecutive iterations may be a predetermined number of iterations (e.g., the number of iterations can be determined before running the process). The number of consecutive iterations may be determined dynamically (e.g., the algorithm determines the number of iterations without an input from a user). The stopping criterion may be that a metric value has reached a value less than or greater than a threshold. The threshold may be a predetermined threshold. The threshold may be a dynamic threshold. If the decision is made that the stopping criterion has not been met, the method 299 may comprise repeating operations 202, 204, and 206. If the stopping criterion is met, the method 299 may comprise operations 208 and/or 210.

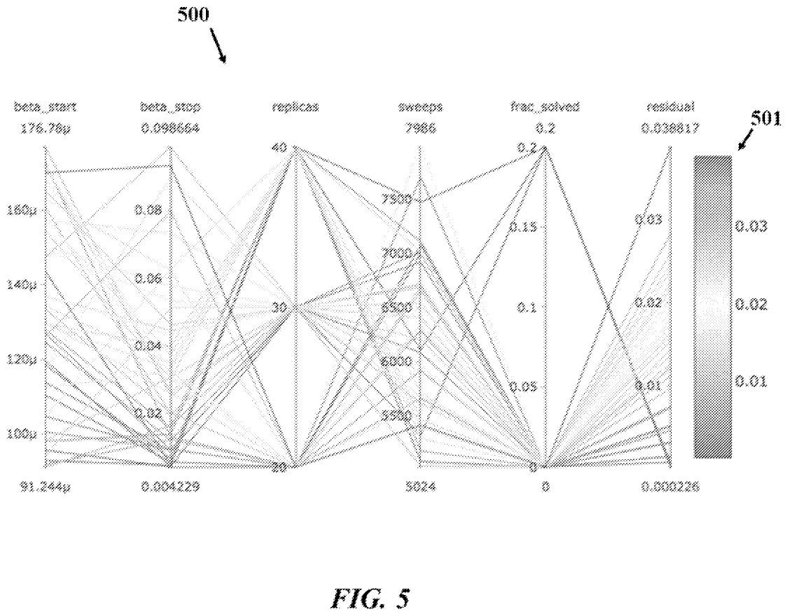

In an operation 208, the method 299 may comprise using the results of the benchmarking (e.g., operation 204) to select at least one hyperparameter configuration. The at least one hyperparameter configuration may be selected based on the results of the computational procedure and the values of the at least one metric. Operation 208 may comprise generating one or more visualizations of the results and/or the at least one metric values. The visualizations may be interactive visualizations (e.g., dynamic to an input of a user). An example of an interactive visualization may be found in FIG. 5. In another operation 210, the method 299 may comprise electronically outputting the selected at least one hyperparameter configuration and/or the corresponding results.

FIG. 3 is an example of a benchmarking procedure 204. The benchmarking procedure may be a part of the process 299 of FIG. 2. For example, the benchmarking procedure can be performed as at least a portion of operation 204. In an operation 300, the procedure 204 may comprise performing the computational procedure for each computational task at least one time. The results of the performing the computational procedure may be stored in the database. The database may be a database as described elsewhere herein. The computational procedure may be performed in parallel (e.g., using multiple processors). In an operation 302, the procedure 204 may comprise calculating values of the at least one metric to evaluate the results. The values may be stored in the database. The values of the at least one metric may be calculated using the digital computer, the computational platform, or a combination thereof.

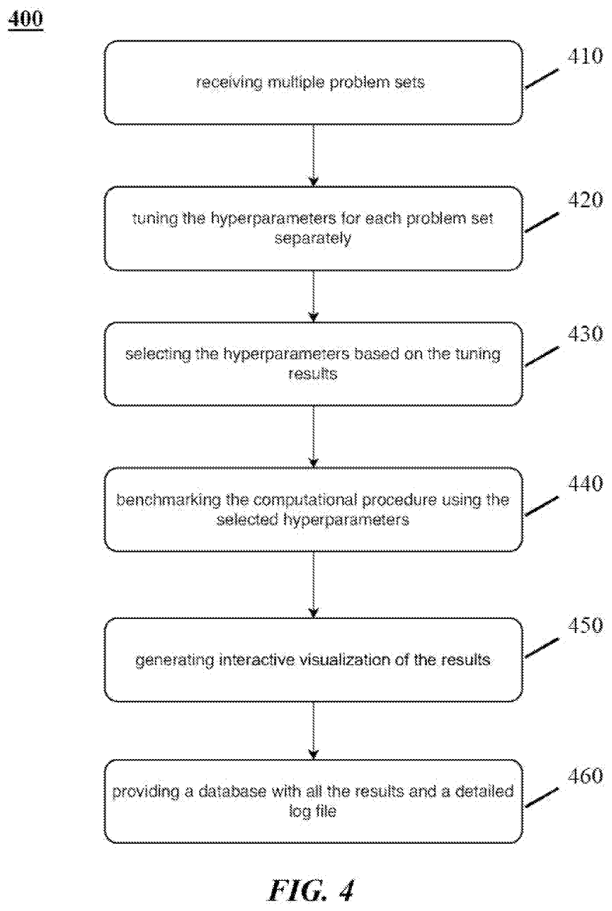

FIG. 4 is a flow chart of an example process for an automated pipeline 400 comprising hyperparameter tuning on one or more problem sets and benchmarking a computational procedure. The automated pipeline may be created using systems and methods as described elsewhere herein (e.g., systems and methods of FIGS. 1-3). In an operation 410, the automated pipeline may comprise receiving multiple problem sets. The problem sets may be problem sets as described elsewhere herein. The multiple problem sets may comprise at least about 2, 3, 4, 5, 10, 15, 25, 50, 100, or more problem sets. The multiple problem sets may comprise at most about 100, 50, 15, 10, 5, 4, 3, or fewer problem sets. In some cases, the multiple problem sets may be a single problem set. In another operation 420, the pipeline 400 may comprise tuning the hyperparameters for each problem set separately. The hyperparameters may be tuned sequentially. The hyperparameters may be tuned in parallel. The hyperparameters may be tuned as described elsewhere herein. The hyperparameter tuning may generate tuning results. The tuning results may comprise one or more indications of the efficacy of the hyperparameters. For example, the tuning results can comprise a residual generated using the hyperparameters. The tuning may comprise selecting a subset of the computational tasks for each problem set and tuning the hyperparameters using the selected subset.

In another operation 430, the pipeline 400 may comprise selecting the hyperparameters based on the tuning results. The selected hyperparameters may be selected based on completion time, accuracy, computational difficulty, or the like, or any combination thereof. In another operation 440, the pipeline 400 may comprise benchmarking the computational procedure using the selected hyperparameters. The benchmarking may be benchmarking as described elsewhere herein. The benchmarking of the selected hyperparameters may be performed in parallel (e.g., at a substantially same time). The benchmarking may be performed sequentially. The benchmarking may comprise applying the different hyperparameters to a same dataset to determine the relative efficacy of the selected hyperparameters. The benchmarking may be performed using the computational tasks that were not selected for tuning the hyperparameters.

In another operation 450, the pipeline 400 may comprise generating an interactive visualization of the results. The results may be the results of operation 440 (e.g., benchmarking results). The visualization may be a visualization on a display of a user device (e.g., a computer screen, a phone screen, etc.). The visualization may be interactive to the user. For example, the user can interact with the visualization to customize the information displayed. The visualization may be configured to rank the results of the benchmarking. The visualization may be configured to enable a comparison by a user of the results. For example, the visualization can simplify the results to be understandable by a user. In another operation 460, the pipeline 400 may comprise providing a database with the results and a detailed log file. The results may be all of the results. The results may be a subset of the results. The database may be a database as described elsewhere herein. The detailed log file may comprise metadata (e.g., data regarding the time the results were generated, the equipment used to generate the results, etc.). The detailed log file may comprise comments from one or more users (e.g., comments regarding the results input by a user).

The pipeline may comprise any combination of operations 410-460. For example, the pipeline can comprise three of the operations. In another example, the pipeline can comprise all of the operations. In another example, the pipeline can comprise one of the operations. The pipeline may comprise any combination of the operations 410-460 in any order.

### Computer Systems

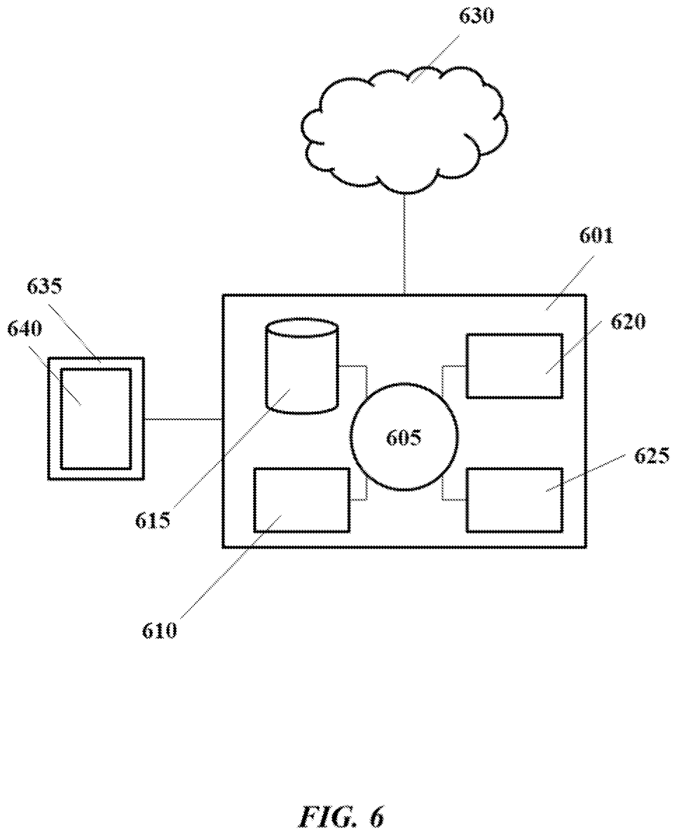

The present disclosure provides computer systems that are programmed to implement methods of the disclosure. FIG. 6 shows a computer system 601 that is programmed or otherwise configured to implement various methods of the present disclosure. The computer system 601 can regulate various aspects of the present disclosure, such as, for example, the process 299 of FIG. 2, the pipeline 400 of FIG. 4, or the like. The computer system 601 can be an electronic device of a user or a computer system that is remotely located with respect to the electronic device. The electronic device can be a mobile electronic device. The computer system 601 may be a computational platform as described elsewhere herein. The computer system 601 may be a digital computer as described elsewhere herein. The computer system 601 may be a database as described elsewhere herein.

The computer system 601 includes a central processing unit (CPU, also “processor” and “computer processor” herein) 605, which can be a single core or multi core processor, or a plurality of processors for parallel processing. The computer system 601 also includes memory or memory location 610 (e.g., random-access memory, read-only memory, flash memory), electronic storage unit 615 (e.g., hard disk), communication interface 620 (e.g., network adapter) for communicating with one or more other systems, and peripheral devices 625, such as cache, other memory, data storage and/or electronic display adapters. The memory 610, storage unit 615, interface 620 and peripheral devices 625 are in communication with the CPU 605 through a communication bus (solid lines), such as a motherboard. The storage unit 615 can be a data storage unit (or data repository) for storing data. The computer system 601 can be operatively coupled to a computer network (“network”) 630 with the aid of the communication interface 620. The network 630 can be the Internet, an internet and/or extranet, or an intranet and/or extranet that is in communication with the Internet. The network 630 in some cases is a telecommunication and/or data network. The network 630 can include one or more computer servers, which can enable distributed computing, such as cloud computing. The network 630, in some cases with the aid of the computer system 601, can implement a peer-to-peer network, which may enable devices coupled to the computer system 601 to behave as a client or a server.

The CPU 605 can execute a sequence of machine-readable instructions, which can be embodied in a program or software. The instructions may be stored in a memory location, such as the memory 610. The instructions can be directed to the CPU 605, which can subsequently program or otherwise configure the CPU 605 to implement methods of the present disclosure. Examples of operations performed by the CPU 605 can include fetch, decode, execute, and writeback.

The CPU 605 can be part of a circuit, such as an integrated circuit. One or more other components of the system 601 can be included in the circuit. In some cases, the circuit is an application specific integrated circuit (ASIC).

The storage unit 615 can store files, such as drivers, libraries, and saved programs. The storage unit 615 can store user data, e.g., user preferences and user programs. The computer system 601 in some cases can include one or more additional data storage units that are external to the computer system 601, such as located on a remote server that is in communication with the computer system 601 through an intranet or the Internet.

The computer system 601 can communicate with one or more remote computer systems through the network 630. For instance, the computer system 601 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 601 via the network 630.

Methods as described herein can be implemented by way of machine (e.g., computer processor) executable code stored on an electronic storage location of the computer system 601, such as, for example, on the memory 610 or electronic storage unit 615. The machine executable or machine-readable code can be provided in the form of software. During use, the code can be executed by the processor 605. In some cases, the code can be retrieved from the storage unit 615 and stored on the memory 610 for ready access by the processor 605. In some situations, the electronic storage unit 615 can be precluded, and machine-executable instructions are stored on memory 610.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 601, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 601 can include or be in communication with an electronic display 635 that comprises a user interface (UI) 640 for providing, for example, visualizations, including interactive visualizations. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 605. The algorithm can, for example, be a method or process as described elsewhere herein.

### EXAMPLES

The following examples are illustrative of certain systems and methods described herein and are not intended to be limiting.

### Example 1

### Tuning an Optimization Solver

For a computational task comprising bin packing problem instance, in which a list of item weights and the capacity of each bin are given, the objective can be to assign the items to the smallest number of bins without going over capacity. The problem can be solved by different solvers. Each solver can have multiple various hyperparameters that can be chosen. For example, a computer procedure comprising an implementation of simulated annealing that has a user provide an initial and final temperature, the type of temperature schedule (e.g., exponential, inverse linear), the number of individual runs to do (e.g., starting from a different random solution), and the number of Monte Carlo operations to perform in each run can be used to solve the problem. In this example, the objective of tuning can be to find the optimal hyperparameter values to use for the aforementioned hyperparameters (e.g., the values that lead to solutions with the lowest number of bins in a given sample of bin packing problems). In this example, the objective of benchmarking can be to determine the objective function value (e.g., the number of bins) and the associated statistics (e.g., the median, various percentiles, etc.) over a given sample (e.g., of bin packing problems). The given sample may be different from the sample used for tuning. In this example, an example of a hyperparameter constraint can be requiring the initial temperature be higher than the final temperature, which can emphasize exploration at the beginning of the optimization and exploitation at the end of it.

### Example 2

### Tuning a Trading Algorithm

Trading algorithms can be computational procedures that take in some data (e.g., historical market data, current market data, stock prices, etc.) and/or other information (e.g., trend information such as Google Trends) to provide a list of trading instructions (e.g., purchase 100 shares of stock X).

An example of a trading algorithm may be a mean reversion strategy. In an example mean reversion strategy, given a particular asset's sequence of prices, an algorithm can calculate a rolling average over a plurality of periods (e.g., two different time periods). The plurality of periods can comprise a slow period (e.g., a longer period) and a fast period (e.g., a shorter period). When a fast-moving average is different from a slow-moving average, the asset can be temporarily overpriced, so a buy/long instruction can be issued. In this example, returns (e.g., price before subtracted from price after and divided by price before) can be considered and not a particular number of assets, and the total return of the trading algorithm can be calculated as a sum of the individual returns (e.g., a positive sign if a buy/long instruction was given). The previous example can also be inverted for a case where the fast-moving average is lower than the slow-moving average leading to sell/short instructions.

A computational procedure can comprise a trading algorithm. A computational task can comprise the input data set. A metric for a trading algorithm can be to maximize a Sharpe ratio (e.g., the mean of the returns divided by a standard deviation of the returns). Such a metric can maximize the expected return while minimizing a standard deviation of the return. The objective of the tuning can be to find the lengths of the slow-moving and fast-moving average periods that maximize the Sharpe ratio over a given period for a given sequence of prices for a given asset. The objective of the benchmarking can be to measure a metric (e.g., the Sharpe ratio) of the strategy for the chosen hyperparameters on data from a period that was not included in the tuning experiment (e.g., out of sample data). An example of a hyperparameter constraint can be requiring the time period associated with the slow-moving average be longer than that associated with the fast-moving average.

### Example 3

### Tuning a Machine Learning Model for Supervised Learning

Supervised learning may be a type of machine learning (ML) in which the parameters of an ML model (e.g., a neural network) can be adjusted to get a best possible metric on in sample data, with a goal of achieving the best possible metric on out of sample data. For example, training a neural network to classify lung x-rays as normal or abnormal by adjusting the parameters of the neural network to maximize the accuracy (e.g., number of correctly predicted examples divided by the total number of examples) on the in sample data can be a computational task. The computational task may be accomplished by using a variant of stochastic gradient descent (e.g., adaptive moment estimation (Adam)), among other computational tasks.

There may exist additional parameters not adjusted in the ML model, but instead treated as fixed, which may be referred to as hyperparameters. The additional parameters may include parameters that control the learning (e.g., learning rate, size of mini-batches, etc.), parameters that define the model (e.g., the number of hidden layers, the dimension of the hidden layers, etc.), or the like, or any combination thereof. The hyperparameters may be optimized by separating the in-sample data into a training set and a validation set. For a given configuration of the hyperparameters, the objective can be to find hyperparameters that give the best metric value (e.g., highest accuracy) on the validation set. The objective of benchmarking may be to measure the metric on out of sample data. The benchmarking may be achieved by first training a model on the full in sample data (e.g., training and validation sets). An example of a hyperparameter constraint for a model with two hidden layers may be having the number of nodes in the second hidden layer be smaller than the number of nodes in the first hidden layer. This may enforce an increasing layer of abstractness as the input goes through the network to where the classification decision is made.

### Example 4

### Interactive Visualization of Results

FIG. 5 is an example of an interactive visualization in static view. In this example, the interactive visualization can show a parallel coordinates plot 500 of a tuning experiment of a parallel tempering computational procedure with hyperparameters that are the inverse initial (e.g., beta start) and inverse final (e.g., beta_stop) temperatures, the number of replicas, and the number of sweeps. The gradient bar 501 can be a legend for the values of the primary metric. The values of the primary metric can also be represented in the residuals column. The other columns can be associated with the computational procedure hyperparameters that may be tuned and/or other metrics (e.g., fraction of solved problems). Each horizontal line may represent a parameter configuration, and the gradient color of the line may depend on the performance of the parameter configuration (e.g., performance according to the primary metric). The visualization shown in FIG. 5 may be a static version of the interactive visualization. The interactive version may be configured to permit a user to filter down the displayed results in one or more ways. Examples of filters include, but are not limited to, filtering to the parameter configurations that give the lowest residuals, the parameter configurations that give the highest residuals, the parameter configurations with a low number of sweeps, or the like, or any combination thereof. For example, the filter can be to all parameter configurations with a low number of sweeps and low residuals.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

What is claimed is:

1. A computer-implemented method, said method comprising:
(a) until a stopping criterion is met:
(i) using a digital computer to generate a hyperparameter configuration from a hyperparameter search space, and storing said hyperparameter configuration in memory;
(ii) using said hyperparameter configuration to perform benchmarking on a computational procedure, said benchmarking comprising:
(A) using a computational platform to:
(I) perform said computational procedure for each computational task of a problem class, wherein said each computational task of said problem class is configured using at least said hyperparameter configuration, and
(II) store a result generated upon performance of said computational procedure in memory, and
(B) calculating a value of at least one metric to evaluate said result corresponding to a performance of said computational procedure, and storing said value in memory;
(b) using said result and said value to select at least one hyperparameter configuration from said hyperparameter configuration of (a); and
(c) electronically outputting said at least one hyperparameter configuration selected in (b) and said result corresponding to said performance of said at least one hyperparameter configuration selected in (b).

2. The method of claim 1, wherein said using said digital computer to generate said hyperparameter configuration from said hyperparameter search space is performed using said result and said value of said at least one metric.

3. The method of claim 1, wherein (a) further comprises obtaining a hyperparameter optimization algorithm, wherein said using said digital computer to generate said hyperparameter configuration is performed using said hyperparameter optimization algorithm.

4. The method of claim 1, wherein (a) further comprises obtaining at least one hyperparameter constraint, wherein said using said digital computer to generate said hyperparameter configuration comprises evaluation of said at least one hyperparameter constraint.

5. The method of claim 1, wherein (c) further comprises generating an interactive visualization of said result and said value.

6. The method of claim 1, wherein said computational task is an optimization task.

7. A system configured to benchmark at least one computational procedure using at least one problem class, each problem class comprising at least one computational task, said system comprising:
(a) a digital computer comprising an interface and a non-transitory computer readable medium operatively coupled to a processor, said non-transitory computer readable medium comprising instructions, wherein said processor is configured to execute said instructions to at least:
(i) generate a hyperparameter configuration from a hyperparameter search space, and store said hyperparameter configuration in memory;
(b) a memory operatively coupled to said digital computer, wherein said memory stores at least a computational result and value of at least one metric; and
(c) a computational platform operatively coupled to said digital computer, said computational platform comprising at least one processor and a readout control system, wherein said computational platform is configured at least to:
(ii) receive from said digital computer said at least one problem class comprising said at least one computational task, said at least one computational procedure, and said hyperparameter configuration, and
(iii) perform said at least one computational procedure using a received hyperparameter configuration to generate a result, and
(iv) via said readout control, store said result of said at least one computational procedure in memory.

8. The system of claim 7, wherein said digital computer comprises multiple processors that are configured to perform said at least one computational procedure in parallel.

9. The system of claim 7, wherein said computational platform is further configured to receive at least one metric for evaluating a performance of said computational procedure and to calculate a value of said at least one metric and store said value in a memory.

10. The system of claim 7, wherein said digital computer is further configured to calculate a value of said at least one metric and store said value in said memory.

11. The system of claim 7, wherein said computational platform comprises at least one member selected from the group consisting: of a field-programmable gate array (FPGA), an application-specific integrated circuit (ASIC), a central processing unit (CPU), a graphics processing unit (GPU), a tensor processing unit (TPU), a tensor streaming processor (TSP), a quantum computer, a quantum annealer, an integrated photonic coherent Ising machine, and an optical quantum computer.

12. The system of claim 7, further comprising a plurality of virtual machines, wherein said plurality of virtual machines are hosted on said computational platform.

13. The system of claim 7, wherein said memory is operatively coupled to said digital computer over a network.

14. The system of claim 7, wherein one or more processors of said at least one processor is located on a cloud.

15. The system of claim 7, wherein said at least one computational procedure comprises an indication of a computer-implemented method and a type of hardware.

16. The system of claim 7, wherein said at least one computational procedure comprises an indication of a meta-solver comprising two or more computational procedures.

17. The system of claim 7, wherein said system is configured to set an automated pipeline.

18. The system of claim 17, wherein said automated pipeline comprises hyperparameter tuning or benchmarking.

19. A method for setting an automated pipeline comprising hyperparameter tuning and benchmarking, said method comprising:
(a) selecting one or more computational procedures;
(b) selecting one or more hardware types;
(c) determining whether to tune a hyperparameter for said selected one or more computational procedures, and, if so determined:
(i) selecting a hyperparameter search space corresponding to said selected one or more computational procedures and said one or more hardware types; and
(ii) providing a selection method for a computational task sample;
(d) receiving an indication to benchmark said selected one or more computational procedures; and
(e) receiving an indication to visualize said tuning and said benchmarking results.

20. The method of claim 19, wherein said one or more hardware types comprises at least two machines, and wherein said automated pipeline comprises:
(a) receiving an indication of at least one problem class comprising a plurality of computational tasks, at least one computational procedure, and at least one metric for evaluating a performance of said at least one computational procedure;
(b) for each problem class of said at least one problem class:
(i) selecting a sample of a computational task of said plurality of computational tasks comprising at least one computational task from said problem class,
(ii) for each computational procedure of said at least one computational procedure:
(A) generating one or more hyperparameter configurations,
(B) using said computational task sample to benchmark said computational procedure, said benchmark comprising performing said computational procedure for each of said selected computational tasks using said at least two machines and evaluating results generated by said performing by calculating values of said at least one metric and storing said values in said database,
(C) providing said results comprising hyperparameter configurations and corresponding computational results,
(D) repeating (A)-(C) until a stopping criterion is met, and
(E) selecting at least one hyperparameter configuration using results of said benchmarking,
(iii) using remaining computational tasks and said hyperparameter configuration to benchmark each of said at least one computational procedure; and
(c) generating an interactive visualization of benchmarking results from (iii) comprising said hyperparameter configurations, corresponding computational results, and values of said at least one metric.
